(19) United States
(12) Patent Application Publication
(10) Pub. No.: US 2016/0149509 A1
(43) Pub. Date: May 26, 2016

(54) CONNECTING POWER PLANTS TO HIGH VOLTAGE NETWORKS

(71) Applicant: SIEMENS AKTIENGESELLSCHAFT, Munchen (DE)

(72) Inventors: Martin HERGT, Nuremberg (DE); Divya KURTHAKOTI CHANDRASHEKHARA, New York, NY (US); Christian SCHACHERER, Hallerndorf (DE)

(73) Assignee: SIEMENS AKTIENGESELLSCHAFT, Munchen (DE)

(21) Appl. No.: 14/550,505

(22) Filed: Nov. 21, 2014

(51) Int. Cl. H02M 7/04; H02J 1/00

(52) U.S. Cl. CPC H02M 7/04; H02J 1/00

(57) ABSTRACT

The invention relates to a Terminal (I) for electrical connection of an amount of electrical generators (1) to a high-voltage transmission network (3), the terminal (I) comprising connected in series in this order for each generator (1) assembly level (Li):
a start AC/DC converter (5) for rectification of the generator voltage(s);
a series resonant converter (7) for galvanic isolation between the generator (1) and the high-voltage;
a converter unit (9) for providing the high-voltage.

The invention concerns a terminal for electrical connection of an amount of electrical generators to a high-voltage-transmission network and in particular a terminal for electrical connection of an amount of electrical wind power generators to a high-voltage direct-current transmission network.

A conventional solution for connection of offshore wind power parks is the usage of conventional components like AC/DC Converters, transformers and a high-voltage direct-current transmission station. With these named components induced voltages from several wind power generators are bundled and transformed to a direct voltage level of for example 320 KV. Consecutively the electrical power is transported with low losses via distances being longer than 70 Km.

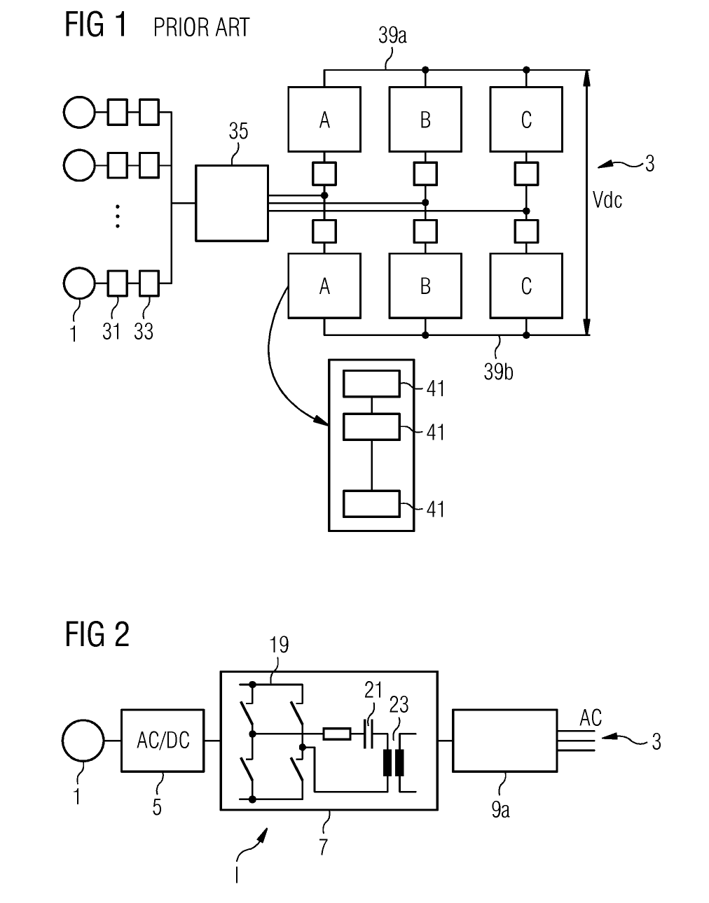

FIG. 1 shows a conventional terminal of individual generators in wind power park facilities. FIG. 1 shows a conventional electrical connection of a wind park facility to a high-voltage direct-current transmission network 3. The voltages of individual wind power generators 1 are converted by a converter 31 and are transformed by transformers 33 and 35 to a high-voltage level. Phases A, B and C of a first arm and of a second arm are provided.

The reference numbers for the arms are 39a and 39b. Between transformer 35 and each level of high-voltage direct-current for each phase an amount of submodules 41 is used. A submodule 41 can comprise a halfbridge and a capacity. FIG. 1 shows a conventional connection of a wind park facility to an high-voltage direct-current transmission system. It shows converters 31 and transformers 33 and 35 and a high-voltage direct-current transmission network 3, whereby their operating frequencies are configured to 50 Hz.

It is an object to connect power plants, in particular wind power plants, to a high-voltage network, in particular a high-voltage direct-current network, whereby a need for space and/or costs and/or complexity is/are reduced in comparison to conventional techniques. A corresponding terminal should be advantageous in particular for offshore facilities.

The object is solved by a terminal comprising the features of the main claim 1 and a method comprising the features of ancillary method claim 13.

According to a first aspect a terminal for electrical connection of an amount of electrical generators to a high-voltage transmission network is suggested, whereby the terminal comprising connected in series in this order for each generator assembly level: a start AC/DC converter for rectification of the generator voltage(s); a series resonant converter for galvanic isolation between the generator and the high-voltage; a converter unit for providing the high-voltage.

Series resonant converters are conventionally used within medicine technology for x-ray generators. The series resonant converters according to this invention are essentially different to the state of the art by application, technical configuration and the compounding of single components.

A boost converter is a DC-to-DC power converter with an output voltage greater than its input voltage. It is a class of switched-mode power supply (SMPS) containing at least two semiconductors (a diode and a transistor) and at least one energy storage element, a capacitor, inductor, or the two in combination.

A series resonant converter consists of an electrical, in particular high frequency semiconductor, switch (e.g. IGBT)-H-bridge and in a shunt arm of a capacity and a transformer called bridge transformer. It generates an electrical AC power out of an electrical DC power.

A voltage multiplier is an electrical circuit that converts AC electrical power from a lower voltage to a higher DC voltage, typically using a network of capacitors and diodes. The most common type of a voltage multiplier is a Villard cascade voltage multiplier which is a half-wave series multiplier.

According to a second aspect a method for controlling a terminal based on the invention is suggested, whereby an adjusting of the high-voltage and a controlling of a power output is performed by setting clock frequency/frequencies, in particular up to 250 KHz or between 20 and 30 MHz, or electrical clock frequency-switch-H-bridge(s) of the used series resonant converter(s).

The invention bases on an inventive topology for the connection of single wind power generators up to the high-voltage level. This topology is more compact and more cost-saving than the conventional technique. Depending on the new technology according to the solution of this invention complexity and therefore need of space of the facility, in particular in the field of offshore facilities, is efficiently reduced. This is a major advantage for the usage for offshore facilities.

Further advantageous embodiments are claimed by the subclaims.

According to an advantageous embodiment the electrical generator(s) can be wind power generator(s), the high-voltage transmission network can transmit direct-current and the terminal can comprise connected in series in the following order for each generator assembly level a start AC/DC converter for rectification of the generator voltage(s); a boost converter for increasing an adjusting the DC generator voltage(s); a series resonant converter for galvanic isolation between the generator and the high-voltage; an AC/DC converter unit for providing the high-voltage direct-current.

According to another advantageous embodiment the terminal can comprise a plurality of generator assembly levels, whereby each AC/DC converter unit is a voltage unit multiplier, in particular a Villard cascade voltage multiplier, their direct voltages can be electrically connected in series into the high-voltage.

According to another advantageous embodiment the terminal can comprise a plurality of generator assembly levels, whereby all their series resonant converters are inductively coupled by a common transformer unit to a common AC/DC converter unit for providing the high-voltage direct-current.

According to another advantageous embodiment the common transformer unit can comprise a primary coil for each series resonant converter and a single common secondary coil, thus adding primary voltages in series and transforming them into the high-voltage.

According to another advantageous embodiment the single common secondary coil can be centrally tapped, thus transforming the added primary voltages into a positive and/or a negative high-voltage.

According to another advantageous embodiment the common transformer unit can comprise a primary coil and a secondary coil for each series resonant converter, thus transforming the primary voltages into the secondary voltages and adding them in series within the common AC/DC converter unit for providing the high-voltage direct-current.

According to another advantageous embodiment each generator assembly level can be formed as a three-phase system.

According to another advantageous embodiment within each generator assembly level for transforming a primary three-coil system and a secondary three-coil system can be formed.

According to another advantageous embodiment each series resonant converter for each phase can consist of an electrical clock frequency-switch-, in particular MOSFET- or JZF- or IGBT-, H-bridge, with a shunt arm comprising a capacity and a bridge transformer.

According to another advantageous embodiment each series resonant converter for each phase can comprise an amount of electrical clock frequency switch-H-bridges electrically connected in parallel to each other.

According to another advantageous embodiment for each shunt arm the capacity and the primary bridge transformer coil can be formed, whereby the AC power of each electrical clock frequency-switch-H-bridge can be inductively added in series by a single common secondary bridge transformer coil formed for all parallel electrical clock frequency-switch-H-bridges.

According to another advantageous embodiment a phase shifted controlling of each electrical frequency-switch-H-bridge connected in parallel to other electrical frequency-switch-H-bridge(s) can be performed.

According to another advantageous embodiment and individual adjustment of the resonance frequency of each electrical frequency-switch-H-bridge can be performed.

According to another advantageous embodiment a setting of the high-voltage can be performed by using the boost converter(s).

According to another advantageous embodiment in case the terminal comprises a plurality of generator assembly levels an equalizing of the DC generator voltages of different generator assembly levels can be performed by using the boost converters.

According to another advantageous embodiment for each three-phase systems each common transformer coil can be minimized in particular in mass or concerning electrical isolation.

The invention is described using embodiments referring to the figures. They show

FIG. 1 an embodiment of a conventional terminal;

FIG. 2 a first embodiment of an inventive terminal;

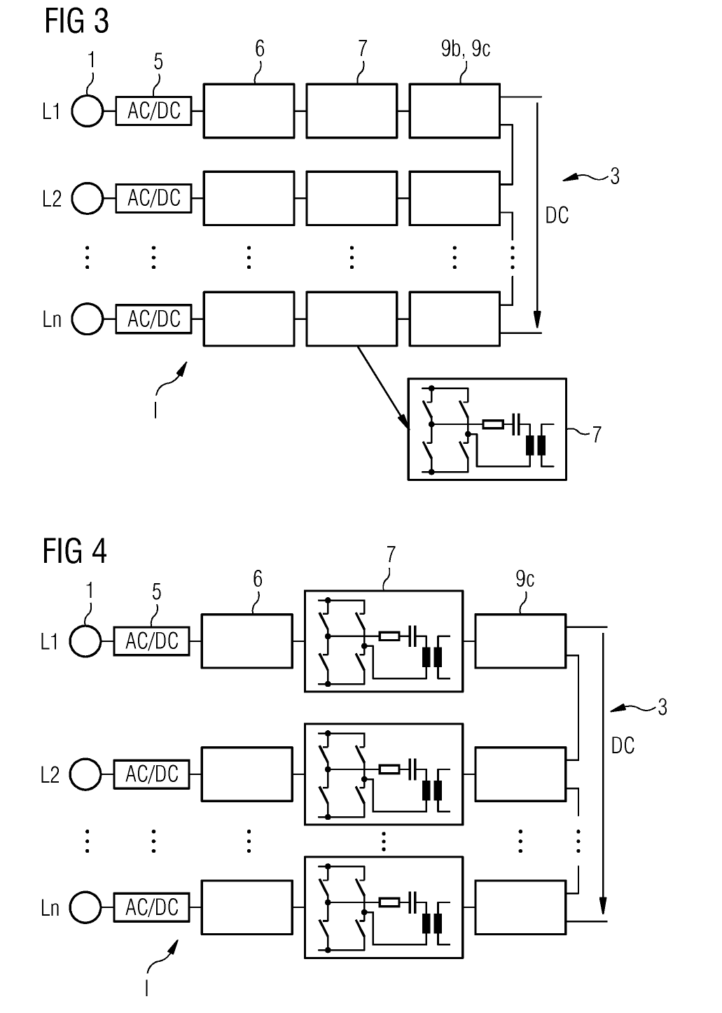

FIG. 3 a first view on a second embodiment of an inventive terminal;

FIG. 4 a second view of the second embodiment of an inventive terminal;

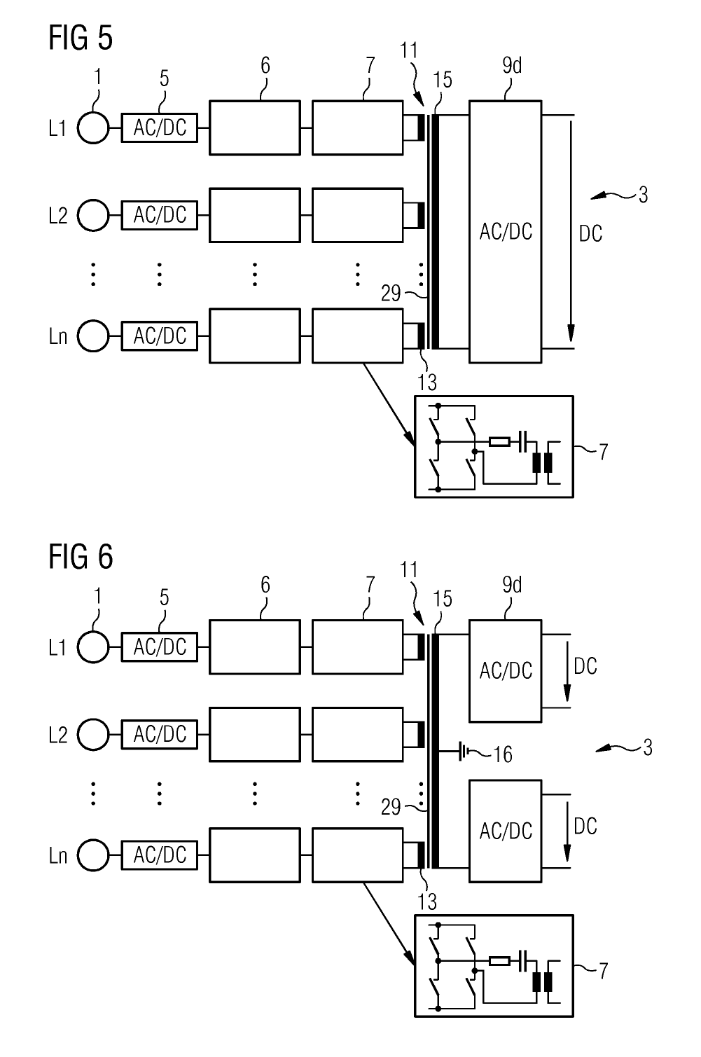

FIG. 5 a third embodiment of an inventive terminal;

FIG. 6 a fourth embodiment of an inventive terminal;

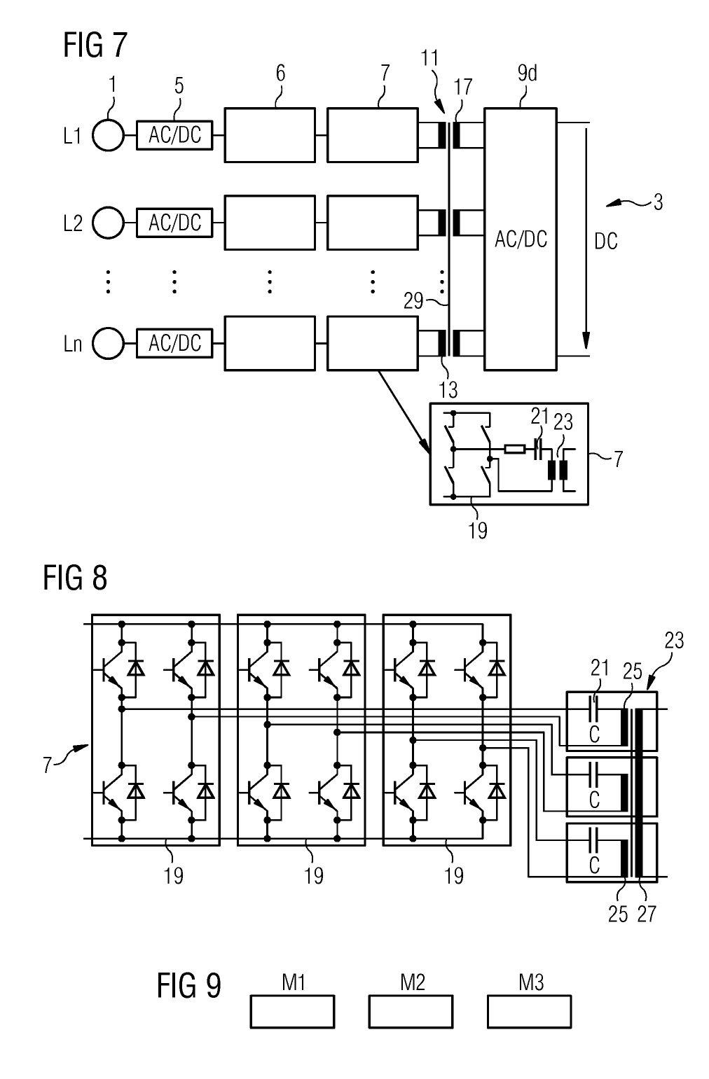

FIG. 7 a fifth embodiment of an inventive terminal;

FIG. 8 another embodiment of an inventive series resonant converter;

FIG. 9 examples of inventive methods.

FIG. 1 shows an embodiment of a conventional terminal. The terminal shown in FIG. 1 connects an amount of electrical generators 1 via converters 31 and transformers 33 and 35 to a high-voltage level to arms of phases A, B and C of a high-voltage direct-current transmission network 3. The branches are indicated by reference numbers 39a and 39b. A unit for providing a phase of an arm comprises submodules 41 each comprising half bridges and capacitors.

FIG. 2 shows a first embodiment of an inventive terminal. FIG. 2 shows a terminal I for electrical connections of an electrical generator 1 to a high-voltage transmission network 3. FIG. 2 shows a single generator 1 assembly level L1, whereby a start AC/DC converter 5 for rectification of the generator voltage or voltages for example for a three-phase system, a series resonant converter 7 for galvanic isolation between the generator 1 and the high-voltage and a converter unit 9 for providing the high-voltage are connected in series in this order. Since according to FIG. 2 the network 3 is a high-voltage alternating-current transmission network the converter unit 9 is here a back-to-back converter 9a. Since FIG. 2 shows a three-phase network 3 the generator 1 generates three phases. This new topology facilitates the connection of generators to high-voltage networks as compact and as low-priced as possible. The series resonant converter 7 consists of a H-bridge 19 with a shunt arm comprising a capacity 21 and a bridge transformer 23. The H-bridge 19 comprises electrical switches, in particular high-frequency switches like insulate gate bipolar transistors (IGBT) or metal oxide semiconductor field effect transistors (MOSFET). The frequencies of the clocks can be in the range of 100 KHz to 250 KHz or between 20 to 30 MHz. For each phase a H-bridge 19 is provided. The H-bridge 19 comprises four arms respectively being switched by an electrical switch, in particular by a semiconductor high-frequency switch.

FIG. 3 shows a second embodiment of an inventive terminal. FIG. 3 shows the terminal I for electrical connection of an amount of wind power generator(s) to a high-voltage direct-current transmission network 3. FIG. 3 shows Ln generator 1 assembly levels. Within each generator 1 assembly level Li a start AC/DC converter 5 for rectification of the generator voltage(s), a boost converter 6 for increasing and adjusting the DC generator voltage(s) a series resonant converter 7 for galvanic isolation between the generator 1 and the high-voltage and an AC/DC converter unit 9b for providing the high-voltage direct-current are connected in series in this order. The AC/DC converter unit 9b for providing the high-voltage direct-current is a voltage multiplier 9c, which is in particular a Villard cascade voltage multiplier. The output direct voltages of the voltage multipliers 9c can be electrically connected in series to provide the high-voltage of direct-current network 3. FIG. 3 shows the junction or link of several wind power generators 1 via the DC converter 5, the boost converter 6, the series resonant converter 7 and the Villard circuit 9c. At the output of the Villard circuit 9c the single voltages of the single generator assembly levels Li were connected in series. According to the respective configuration of the single generator assembly levels Li different direct voltages can be generated. Corresponding to the amount of single generator assembly levels Li middle or high-voltages can be generated. According to the present state of the art there exist semiconductor switches with cut off voltages up to 10 KV, which can be connected in serie using a suitable circuit. The frequency switches, in particular semiconductor switches, within a series resonant converter 7 is the limiting element in a chain referring to current and voltage.

FIG. 3 shows the new topology for the link of the single wind power generators 1 up to the high-voltage level. This topology is more compact and more economic than the conventional technique. Because of the new technology complexity and thus need of space of the facility, in particular for the offshore area, is efficiently reduced. This is especially advantageous in the field of offshore facilities. FIG. 3 shows the link of the wind power generators 1 via the AC/DC-converter 5, the boost converter 6, the series resonant converter 7 and the Villard circuit 9c to the high-voltage direct-current. The reason for the compact mounting form of the link or of the connection is the high clock frequency of the series resonant converter 7, which in particular is in the range of KHz. Because of the high clock frequency the single components must be compacted integrated in space to prevent electromagnetic couplings and emissions. The minimized mounting form of the wind facility terminal I is determined by the losses within transformers and the semiconductor switches in particular within the series resonant converters 7.

FIG. 4 shows a second view of the second embodiment of the inventive terminal. The terminal I shows the arrangement of the series resonant converter 7 in the new topology for the wind power generator 1 link. FIG. 4 shows the interior for all series resonant converters 7 of all generator assembly levels Li. The high-voltage of the high-voltages direct-current network 3 can be for example 320 KV. Since within the series resonant converters 7 bridge transformers 23 are used the wind power generators 1 are galvanically decoupled to the high-voltage direct-current transmission network 3. According to the circuit ??concept?? of the terminal I there are the following advantageous: There is a galvanic isolation between the generators 1 and the high-voltage of the network 3, the mass-potentials can be flexibly set at the output of the Villard circuit 9c, an implementation can be in positive and/or negative polarity according to the application. Basing on the flexible setting of mass or earth potentials the mass point can be selected such that a minimal effort for isolation is needed. Especially a symmetrical grounding in the middle of the system at the output of the Villard circuit 9c is possible.

FIG. 5 shows a third embodiment of an inventive terminal I. The terminal I comprises a plurality of generator assembly levels L1 . . . Ln, whereby all the series resonant converters 7 are inductively coupled by a common transformer unit 11 to a common AC/DC converter unit 9d for providing the high-voltage direct-current.

According to FIG. 5 the power generator 1 link is provided via an inductive voltage addition into the high-voltage direct-current network 3. According to this embodiment the common transformer unit 11 comprises a primary coil 13 for each series resonant converter 7 and a single common secondary coil 15, thus adding primary voltages in series and transforming them into the high-voltage. Then the high-voltage is DC converted by the common AC/DC converter unit 9d. Reference number 29 refers to the common coil of the common transformer unit 11. FIG. 5 shows the arrangement of the series resonant converters 7, whereby the single voltages are correspondingly inductively added and the resulting over-all voltage is converted via the common AC/DC converter 9d into the direct-current of the high-voltage direct-current transmission network 3. This embodiment gives the following advantages. The embodiment can be provided with low losses. In case of damage of one of the series resonant converters 7 the over-all voltage can be maintained because of redundance.

FIG. 6 shows a fourth embodiment of the inventive terminal I. FIG. 6 shows the terminal I of FIG. 5 but with the single common secondary coil 15 being centrally tapped, thus bipolar direct voltage can be generated. The added primary voltages can be transformed into a positive and/or a negative high-voltage. FIG. 6 shows an embodiment of the common transformer unit 11, whereby its secondary side comprises a central tapping 16. By implementing this central tapping 16 the effort for isolation of the common transformer unit 11 is minimized and it can be respectively induced a positive and a negative voltage. Via the common AC/DC converter unit 9d the corresponding direct voltage can be generated.

FIG. 7 shows a fifth embodiment of the inventive terminal I. The terminal I comprises a plurality of generator assembly levels L1 . . . Ln, whereby all their series resonant converters 7 are inductively coupled by a common transformer unit 11 to a common AC/DC converter unit 9d for providing the high-voltage direct-current. According to this embodiment the common transformer unit 11 comprises a primary coil 13 and a secondary coil 17 for each series resonant converter 7, thus transforming the primary voltages into the secondary voltages and adding them in series within the common AC/DC converter unit 9d for providing the high-voltage direct current.

Additionally all embodiments referring to the terminal I according to the idea of this application can comprise generator assembly levels formed as three-phase systems. Accordingly all transformers have to be three-phased transformers. Accordingly within each generator assembly level Li for each transforming a primary three-coil-system and a secondary three-coil-system is created. Accordingly FIG. 7 also shows the embodiment of the common transformer unit 11 within a three-phase system. Caused by the three different phases, which are phase-shifted respectively by 120°, the common coil 29 can be minimized. Via the common AC/DC converter unit 9d the associated direct-voltage is generated. In all embodiments the value for the high-voltage of the high-voltage direct-current transmission network 3 can be for example 320 KV.

FIG. 8 shows a further embodiment of series resonant converter 7 according to this invention. According to the present state of the art in particular the semiconductor electronic components are responsible for the power transmission of generator terminals, which depends on the losses, the electric strength and the ampacity of the individual components. To enable an increased power transmission a parallel connection of electronic components, in particular of electronic semiconductors or electronic semiconductor switches, can be performed. FIG. 8 shows a possible implementation, where series resonant converters 7 for each phase comprise a certain amount of H-bridges 19 is electrically connected in parallel to each other. Especially if their switches are provided by high-frequency semiconductor switches like IGBT or MOSFET a power-flow can be increased. FIG. 8 shows a parallel connection of three series resonant converters 7 of one phase, whereby the single voltages are inductively added. FIG. 8 shows that for each shunt arm a capacity 21 and a primary bridge transformer coil 25 are formed, whereby the AC power of each electrical clock frequency-switch-H-bridge 19 is inductively in series by a single common secondary bridge transformer coil 27 formed for all these three parallel electrical clock frequency-switch-H-bridges 19. The advantages of this embodiment are, that the power of each H-bridge 19 within the series resonant converter 7, are inductively added via the bridge transformer 23. This implementation gives various freedom degrees, which are usable for the corresponding application. Basing on this embodiment the following advantages can be achieved: By usage of the parallel connection three times of the power can be transmitted. To minimize the coil volume of the bridge transformer 23 the single H-bridges 19 can be driven by phase-shift control. For generating of different voltage-current-shapes the resonant frequency of the single H-bridges 19 can be individually adjusted. To increase the power transmission of a series resonant converter 7 other amount of single H-bridges 19 can be connected in parallel, for example also four or five single H-bridges 19 can be connected in parallel.

FIG. 9 shows embodiments of methods for controlling or driving a terminal I according to the present invention. A terminal I can be provided according to one of the embodiments of the present invention. In particular the embodiment according FIG. 3 using series resonant converters 7 in combination with Villard cascade voltage multipliers 9c can provide a compact construction shape and can be controlled by one or more of the following methods.

According to a first method M1 the high-voltage of high-voltage direct-current transmission network 3 can be adjusted and the output power of each generator one assembly level Li can be controlled by setting the clock frequencies switching each h-bridge 19.

According to a second method M2 the high-voltage of the high-voltage direct-current transmission network 3 can be set by each boost converter 6. Additionally by a method step M3 in case the terminal comprises a plurality of generator 1 assembly levels L1 . . . Ln all boost converters 6 can be used for equalizing of all DC generator 1 voltages of the different generators 1. To sum up a regulation of the over-all output voltage can be performed by using the boost converters 6 and setting the clock frequency within the series resonant converters 7. The clock frequency of a series resonant converter 7 is proportional to the output power of this series resonant converter 7.

1. Terminal (I) for electrical connection of an amount of electrical generators (1) to a high-voltage transmission network (3), the terminal (I) comprising connected in series in this order for each generator (1) assembly level (Li):
a start AC/DC converter (5) for rectification of the generator voltage(s);
a series resonant converter (7) for galvanic isolation between the generator (1) and the high-voltage;
a converter unit (9) for providing the high-voltage.

2. Terminal (I) according to claim 1,
characterized by that
the electrical generator(s) (1) is/are (a) wind power generator(s), the high-voltage transmission network (3) transmits direct-current and the terminal (I) comprising connected in series in this order for each generator (1) assembly level (Li):
a start AC/DC converter (5) for rectification of the generator voltage(s);
a boost converter (6) for increasing and adjusting the DC generator voltage(s);
a series resonant converter (7) for galvanic isolation between the generator (1) and the high-voltage;
an AC/DC converter unit (9b) for providing the high-voltage direct-current.

3. Terminal according to claim 2,
characterized by that
the terminal (I) comprises a plurality of generator assembly levels (L1 . . . Ln), whereby each AC/DC converter unit is a voltage multiplier (9c), in particular a Villard cascade voltage multiplier, their direct voltages are electrically connected in series into the high-voltage.

4. Terminal according to claim 2,
characterized by that
the terminal (I) comprises a plurality of generator assembly levels (L1 . . . Ln), whereby all their series resonant converters (7) are inductively coupled by a common transformer unit (11) to a common AC/DC converter unit (9d) for providing the high-voltage direct-current.

5. Terminal according to claim 4,
characterized by that
the common transformer unit (11) comprises a primary coil (13) for each series resonant converter (7) and a single common secondary coil (15), thus adding primary voltages in series and transforming them into the high-voltage.

6. Terminal according to claim 5,
characterized by that
the single common secondary coil (15) is centrally tapped, thus transforming the added primary voltages into a positive and/or a negative high-voltage.

7. Terminal according to claim 4,
characterized by that
the common transformer unit (11) comprises a primary coil (13) and a secondary coil (17) for each series resonant converter (7), thus transforming the primary voltages into the secondary voltages and adding them in series within the common AC/DC converter unit (9d) for providing the high-voltage direct-current.

8. Terminal according to claim 1,
characterized by that
each generator assembly level (Li) is formed as a three-phase system.

9. Terminal according to claim 8,
characterized by that
within each generator assembly level (Li) for transforming a primary three-coil-system and a secondary three-coil-system is formed.

10. Terminal according to claim 1,
characterized by that
each series resonant converter (7) for each phase consists of an electrical clock frequency-switch-, in particular MOSFET- or JZF- or IGBT-, H-bridge (19) with a shunt arm comprising a capacity (21) and a bridge transformer (23).

11. Terminal according to claim 10,
characterized by that
each series resonant converter (7) for each phase comprises an amount of electrical clock frequency-switch-H-bridges (19) electrically connected in parallel to each other.

12. Terminal according to claim 11,
characterized by that
for each shunt arm the capacity (21) and the primary bridge transformer coil (25) are formed, whereby the AC power of each electrical clock frequency-switch-H-bridge (19) is inductively added in series by a single common secondary bridge transformer coil (27) formed for all parallel electrical clock frequency-switch-H-bridges (19).

13. A method for controlling a terminal for electrical connection of at least one electrical generator to a high-voltage transmission network, the terminal having connected in series in order for each generator assembly level: a start AC/DC converter for rectification of generator voltage; a series resonant converter, including an electrical clock frequency-switch-H-bridge, for galvanic isolation between the generator and the high-voltage transmission network; and a converter unit for providing high-voltage, said method comprising:
adjusting the high-voltage and controlling a power output by setting at least one clock frequency, in particular up to 250 KHz or between 20 and 30 MHz, for the electrical clock frequency-switch-H-bridge of each series resonant converter.

14. Method for controlling a terminal according to claim 13,
characterized by phase shifted controlling of each electrical frequency-switch-H-bridge (19) connected in parallel to other electrical frequency-switch-H-bridge(s) (19).

15. Method for controlling a terminal according to claim 13,
characterized by individual adjustment of the resonance frequency of each electrical frequency-switch-H-bridge (19).

16. Method for controlling a terminal according to claim 13,
characterized by (M2) setting of the high-voltage using the boost converter(s) (6).

17. Method for controlling a terminal according to claim 13,
characterized by in case the terminal (I) comprises a plurality of generator assembly levels (L1 . . . Ln) an (M3) equalizing of the DC generator voltages of different generator assembly levels using the boost converters (6) is performed.

18. Method for controlling a terminal according to one of the precedent claims 13,
characterized by for each three-phase-system each common transformer core (29) is minimized in mass.
